(19) United States
(12) Patent Application Publication
(10) Pub. No.: US 2026/0319334 A1
(43) Pub. Date: Oct. 15, 2026

(54) CONTROL APPARATUS, LENS APPARATUS, IMAGE PICKUP APPARATUS, CAMERA SYSTEM, CONTROL METHOD, AND STORAGE MEDIUM

(71) Applicant: CANON KABUSHIKI KAISHA, Tokyo (JP)

(72) Inventor: Takeo MORI, Tochigi (JP)

(21) Appl. No.: 19/567,521

(22) Filed: Mar. 16, 2026

(30) Foreign Application Priority Data
Apr. 15, 2025 (JP) 2025-066620

(51) Int. Cl. G03B 13/34

(52) U.S. Cl. CPC G03B 13/34

(57) ABSTRACT

A control apparatus for a camera system that includes an image sensor and an optical system that includes a shift unit configured to move in a direction orthogonal to an optical axis to tilt a focal plane relative to an imaging surface of the image sensor may include one or more memories storing instructions, and one or more processors that, upon execution of the instructions, operate to acquire optical information on the shift unit, and focus detection results in a target region set in a captured image obtained by the image sensor, and control movement of the shift unit according to the optical information and the focus detection results. The optical information may include information on a relationship between a moving amount of the shift unit and a moving amount along the optical axis of a focal position at each image height on the imaging surface.

### BACKGROUND

### Field of the Technology

The present disclosure relates to a control apparatus, a lens apparatus, an image pickup apparatus, a camera system, a control method, and a storage medium.

### Description of the Related Art

A configuration having a tilt imaging (tilt shooting) function that brings an entire object surface into focus when the object surface is tilted relative to an optical axis of an optical system has conventionally been proposed (see Japanese Patent Application Laid-Open No. 2023-140195).

In the configuration disclosed in Japanese Patent Application Laid-Open No. 2023-140195, movement of an image sensor and a lens is controlled based on the Scheimpflug principle. More specifically, the three-dimensional arrangement of the object surface and the image plane is estimated, and the image sensor and the lens are moved based on the estimated three-dimensional arrangement. Therefore, it is difficult to automatically perform tilt imaging in a high-speed and simple manner.

### SUMMARY

A control apparatus according to one aspect of the present disclosure for a camera system that includes an image sensor and an optical system that includes a shift unit configured to move in a direction orthogonal to an optical axis to tilt a focal plane relative to an imaging surface of the image sensor may include one or more memories storing instructions, and one or more processors that, upon execution of the instructions, operate to acquire optical information on the shift unit, and focus detection results in a target region set in a captured image obtained by the image sensor, and control movement of the shift unit according to the optical information and the focus detection results. The optical information may include information on a relationship between a moving amount of the shift unit and a moving amount along the optical axis of a focal position at each image height on the imaging surface. A lens apparatus, an image pickup apparatus, and a camera system each having the above control apparatus also constitute another aspect of the present disclosure. A control method corresponding to the above control apparatus also constitutes another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a configuration of a camera system according to this embodiment of the present disclosure.

FIG. 2 illustrates an example of optical information on a shift unit according to an embodiment of the present disclosure.

FIGS. 3A and 3B illustrate an example of a method of calculating a moving amount of the shift unit according to this embodiment of the present disclosure.

FIG. 4 illustrates an example of a control method according to this embodiment of the present disclosure.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

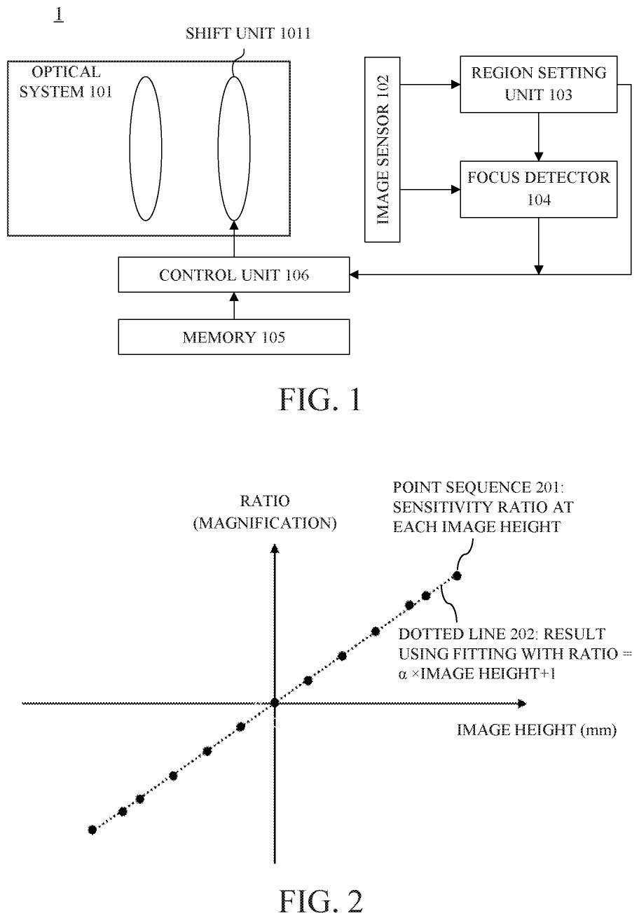

FIG. 1 illustrates an example of a configuration of a camera system 1 according to an embodiment of the present disclosure. The camera system 1 may be a lens-integrated type camera, or may include a lens apparatus and an image pickup apparatus (camera body) to which the lens apparatus is attachable.

The camera system 1 includes an optical system 101, an image sensor 102, a region setting unit 103, a focus detector 104, a memory 105, and a control unit 106.

The optical system 101 includes a shift unit 1011 that is movable in a direction orthogonal to an optical axis. By moving the shift unit 1011 in the direction orthogonal to the optical axis, tilt imaging can be performed in which a focal plane is tilted relative to an imaging surface of the image sensor 102. The present embodiment provides only a single shift unit 1011.

The image sensor 102 photoelectrically converts an object image (optical image) formed by light that has passed through the optical system 101, into an electrical signal. The image sensor 102 includes, for example, a charge-coupled device (CCD) sensor or a complementary metal-oxide-semiconductor (CMOS) sensor, and includes a plurality of focus detecting pixels having different image heights on an imaging surface.

The region setting unit 103 includes a display apparatus or the like that outputs a captured image based on an electrical signal output from the image sensor 102, and sets a target region within the captured image to be focused, according to a user instruction. In the present embodiment, the region setting unit 103 sets a single target region within the captured image.

The focus detector 104 performs focus detection for detecting a defocus amount of an object image, based on information from focus detecting pixels located in the target region set by the region setting unit 103. A focus detection result obtained by the focus detector 104 is output to the control unit 106. In some cases, tilt imaging is performed by moving the image sensor; however, in such a case, when an incident angle of light rays incident on the image sensor changes significantly, light rays required for phase-difference detection may fail to enter the image sensor, which makes it difficult to detect the defocus amount. In the present embodiment, tilt imaging is performed by moving the shift unit 1011, thereby suppressing a situation in which light rays for phase-difference detection fail to enter the image sensor and detection of the defocus amount becomes difficult.

The memory 105 is a memory such as a Read Only Memory (ROM), and stores optical information indicating a relationship between a state of the optical system 101 and an optical characteristic. The state of the optical system 101 includes, for example, a zoom position, a focus position, an aperture diameter, and a position of the shift unit 1011 in the optical axis direction. The optical information includes information on a relationship between a moving amount of the shift unit 1011 and a moving amount of a focus position along the optical axis at each image height, and it is information corresponding to the state of the optical system 101 and the image height. The optical information includes, for example, a focus moving amount (sensitivity information) when the shift unit 1011 moves by a unit length (such as 1 mm) in a direction orthogonal to the optical axis. Since each image height sensitivity of the shift unit 1011 is asymmetric with respect to the center of the optical axis, sensitivity information for negative image heights may be included. To reduce the amount of stored information, a ratio (sensitivity ratio) of a focus moving amount at each image height to a focus moving amount on the optical axis may be fitted using a polynomial, and a coefficient may be stored as a sensitivity correction coefficient.

The control unit 106 controls the entire camera system 1 and includes a central processing unit (CPU) (serving as one or more processors), one or more memories, and the like, thereby configuring a control apparatus used in the camera system 1. The one or more memories store instructions, and the CPU that, upon execution of the instructions, operate to acquire optical information on the shift unit 1011, and focus detection results in a target region set in a captured image obtained by the image sensor 102, and control movement of the shift unit 1011 based on the optical information and the focus detection results. In a case where the camera system 1 includes a lens apparatus and an image pickup apparatus to which the lens apparatus is attachable, the control unit 106 may be provided in the lens apparatus or in the image pickup apparatus. At least one of the region setting unit 103, the focus detector 104, and the memory 105 may be included in the control apparatus.

The control unit 106 acquires, from the memory 105, optical information based on a state of the optical system detected by a position detection sensor (not illustrated) and position information (coordinate information) on the target region set by the region setting unit 103. The control unit 106 also acquires a defocus amount corresponding to the target region detected by the focus detector 104, and set by the region setting unit 103. That is, the control unit 106 functions as an acquiring unit. The control unit 106 calculates a moving amount of the shift unit 1011 based on the acquired information, and controls the movement of the shift unit 1011 via an actuator such as a stepping motor (not illustrated), using the calculated moving amount. In the present embodiment, movement of the shift unit 1011 can be controlled without using the Scheimpflug principle, that is, without using object distance information on an object or principal point position information on the optical system 101. That is, automatic tilt imaging can be performed more quickly and simply than in a case where the Scheimpflug principle is used.

FIG. 2 illustrates an example of optical information on the shift unit 1011 in a predetermined state of the optical system 101. In FIG. 2, the horizontal axis represents image height (unit: mm), and the vertical axis represents a sensitivity ratio. For example, as optical information on the shift unit 1011, a sensitivity ratio, which is a ratio of a focus moving amount at each image height to a focus moving amount on the optical axis, may be stored as illustrated by a graph point sequence 201. In this case, a sensitivity ratio at a target image height may be calculated by linear interpolation of two pieces of sensitivity ratio information closest to the target image height. Alternatively, as optical information on the shift unit 1011, a sensitivity correction coefficient α fitted by a linear equation having an intercept of 1.0, as illustrated by a dashed line 202, may be stored. In this case, the amount of stored information can be reduced.

Due to the characteristic of tilt imaging, the sensitivity ratio tends to linearly increase as the image height increases. Strictly speaking, the characteristic differs between positive and negative image heights. Therefore, when fitting using a polynomial, the focusing accuracy can be improved by considering the negative image height characteristic.

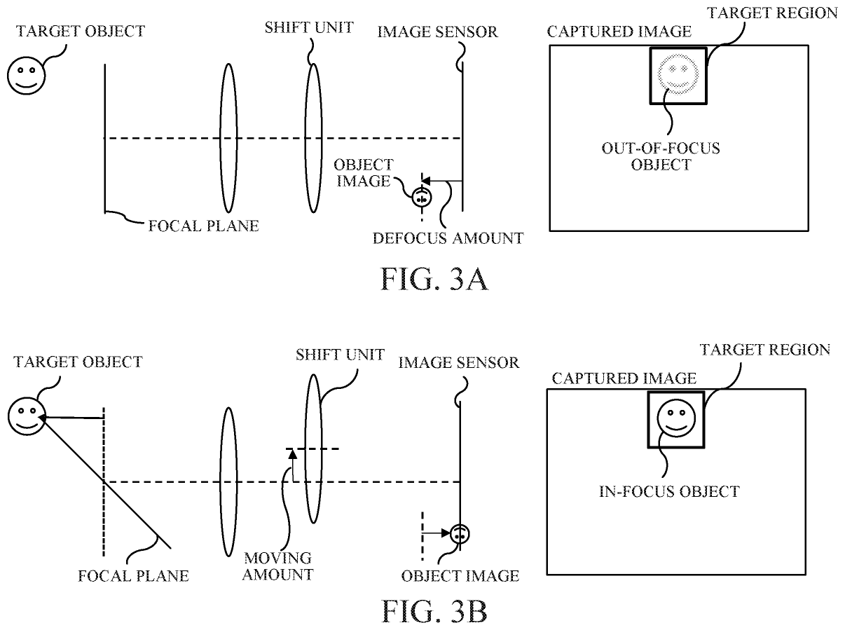

Next, a method of calculating a moving amount of the shift unit 1011 will be described. FIGS. 3A and 3B illustrate an example of a method of calculating a moving amount of the shift unit 1011. FIG. 3A illustrates a state where the target object is not in focus. The target object distant from the focal plane for the image sensor 102 is imaged in front of the image sensor 102 through the optical system 101, so that the output image is an out-of-focus blurred image. In a case where the target region is set to an out-of-focus object, a moving amount of the shift unit 1011 in the direction orthogonal to the optical axis can be calculated using the following equation (1):

M=DEF/S (1)

where M is a moving amount of the shift unit 1011 in the direction orthogonal to the optical axis, DEF is a detected defocus amount, and S is a sensitivity of the shift unit 1011.

FIG. 3B illustrates a state where the focal plane tilts due to movement of the shift unit 1011, bringing the target object into focus.

While FIGS. 3A and 3B illustrate an example in which the shift unit 1011 moves in the vertical direction, the shift unit 1011 may also move in a direction perpendicular to the paper plane.

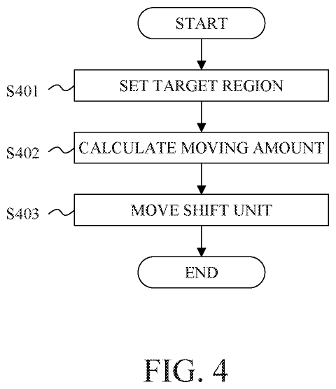

Next, a control method for the camera system 1 will be described. FIG. 4 illustrates an example of the control method.

In step S401, the region setting unit 103 sets a target region. In the present embodiment, the region setting unit 103 sets an arbitrary region designated by a user as the target region. The region setting unit 103 may also automatically set, as the target region, positions detected by a function for detecting a specific object. For example, a region indicating an object recognized by a face recognition function may be automatically set as a target region.

In step S402, the control unit 106 first acquires the state of the optical system 101, the optical information, the position information of the target region, and the focus detection results. Next, the control unit 106 calculates the moving amount of the shift unit 1011 using equation (1) from the focus detection results and the sensitivity of the shift unit 1011 corresponding to the target region in the state of the optical system.

In step S403, the control unit 106 moves the shift unit 1011.

As described above, the configuration of the present embodiment can automatically and easily bring intended objects into focus during tilt imaging.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present embodiment can provide a control apparatus that can perform fast, simple, and automatic tilt imaging.

This application claims the benefit of Japanese Patent Application No. 2025-066620, filed on Apr. 15, 2025, which is hereby incorporated by reference herein in its entirety.

What is claimed is:

1. A control apparatus for a camera system that includes an image sensor and an optical system that includes a shift unit configured to move in a direction orthogonal to an optical axis to tilt a focal plane relative to an imaging surface of the image sensor, the control apparatus comprising:
one or more memories storing instructions; and
one or more processors that, upon execution of the instructions, operate to:
acquire optical information on the shift unit, and focus detection results in a target region set in a captured image obtained by the image sensor, and
control movement of the shift unit according to the optical information and the focus detection results,
wherein the optical information includes information on a relationship between a moving amount of the shift unit and a moving amount along the optical axis of a focal position at each image height on the imaging surface.

2. The control apparatus according to claim 1, wherein the one or more processors operate to calculate a moving amount along a direction from an optical axis center to the target region, and control movement of the shift unit using the moving amount.

3. The control apparatus according to claim 1, wherein the optical information is information corresponding to a state of the optical system.

4. The control apparatus according to claim 3, wherein the optical information is information corresponding to a position of the shift unit in an optical axis direction.

5. The control apparatus according to claim 3, wherein the optical information is information corresponding to an aperture diameter of the optical system.

6. The control apparatus according to claim 1, wherein the optical information includes a focus moving amount at each image height in a case where the shift unit moves by a unit length.

7. The control apparatus according to claim 1, wherein the optical information includes a ratio of a focus moving amount at each image height to a focus moving amount on the optical axis.

8. The control apparatus according to claim 1, wherein the optical information includes a coefficient obtained by fitting, using a polynomial, a ratio of a focus moving amount at each image height to a focus moving amount on the optical axis.

9. The control apparatus according to claim 8, wherein the coefficient is acquired by fitting including a value at a negative image height.

10. The control apparatus according to claim 1, wherein the one or more processors operate to calculate a sensitivity of the shift unit in the target region based on a state of the optical system, the optical information, and position information on the target region.

11. The control apparatus according to claim 10, wherein the one or more processors operate to calculate a moving amount of the shift unit using the following equation:
M=DEF/S
where M is the moving amount of the shift unit, DEF is a defocus amount of an object in the target region, and S is the sensitivity of the shift unit.

12. The control apparatus according to claim 1, wherein the one or more processors operate to calculate a moving amount of the shift unit without using object distance information of an object.

13. The control apparatus according to claim 1, wherein the one or more processors operate to calculate a moving amount of the shift unit without using principal point position information of the optical system.

14. The control apparatus according to claim 1, wherein the one or more memories further store the optical information.

15. The control apparatus according to claim 1, wherein the one or more processors operate to set the target region in the captured image.

16. The control apparatus according to claim 1, wherein the one or more processors operate to perform focus detection in the target region, and output the focus detection results.

17. The control apparatus according to claim 1, wherein only a single target region is set in the captured image.

18. A control apparatus for a camera system that includes an image sensor and an optical system that includes a single shift unit configured to move in a direction orthogonal to an optical axis to tilt a focal plane relative to an imaging surface of the image sensor, the control apparatus comprising:
one or more memories storing instructions; and
one or more processors that, upon execution of the instructions, operate to:
acquire optical information on the single shift unit, and focus detection results in a target region set in a captured image obtained by the image sensor, and
control movement of the single shift unit based on the optical information and the focus detection results.

19. A lens apparatus comprising:
the control apparatus according to claim 1; and
the optical system.

20. An image pickup apparatus comprising:
the control apparatus according to claim 1; and
the image sensor.

21. A camera system comprising:
the control apparatus according to claim 1;
the optical system; and
the image sensor.

22. A control method for a camera system that includes an image sensor and an optical system that includes a shift unit configured to move in a direction orthogonal to an optical axis to tilt a focal plane relative to an imaging surface of the image sensor, the control method comprising:
acquiring optical information on the shift unit, and focus detection results in a target region set in a captured image obtained by the image sensor; and
controlling movement of the shift unit according to the optical information and the focus detection results,
wherein the optical information includes information on a relationship between a moving amount of the shift unit and a moving amount along the optical axis of a focal position at each image height on the imaging surface.

23. A non-transitory computer-readable storage medium storing a program that causes a computer to execute the control method according to claim 22.
